(19) United States
(12) Patent Application Publication
(10) Pub. No.: US 2011/0168716 A1
(43) Pub. Date: Jul. 14, 2011

(54) GROUND LEVEL CLOSURE

(75) Inventors: Mark Stransky, Munroe Falls, OH (US); Chris Grubish, Solon, OH (US); Michael Avery, Eastlake, OH (US)

(73) Assignee: Preformed Line Products Company, Mayfield Village, OH (US)

(21) Appl. No.: 12/685,021

(22) Filed: Jan. 11, 2010

(51) Int. Cl. B65D 88/76; B23P 11/00

(52) U.S. Cl. 220/484; 29/428

(57) ABSTRACT

A ground level closure (GLC) that can address deficiencies found with traditional pedestal installations is disclosed. The GLC can combine benefits of a sealed (e.g., hermetically sealed) system with functionality of a pedestal style enclosure. Additionally, the GLC can provide an ability to store slack cable in an internal cavity of the base assembly. Further, the GLC can provide simplified access to and isolation of grounding elements without disrupting the sealed portion (e.g., internal organizer assembly) of the enclosure during inspection and troubleshooting. Moreover, spacers can be employed to adjust height and/or angle of installation.

### BACKGROUND

Oftentimes, power distribution, cable television and telephony equipment connections, splices and splitters are located outside and exposed to environmental and other potentially destructive factors. Accordingly, protective coverings or closures are employed to house cable, connections and components.

Traditional above-ground enclosures for the communication and cable industry are known as “pedestals.” Traditionally, these pedestal-type enclosures are manufactured in various shapes, sizes and materials. Unfortunately, conventional systems have limited or no storage capacity for uncut slack cable and are fixed in the position in which they are installed. In other words, once installed, conventional closures cannot be positionally adjusted (e.g., raised or lowered) without excavating and re-installing. During installation, the lower portion of a pedestal closure assembly is most often buried beneath the ground and secured in place with packed dirt and often a metal stake. If the topography changes after installation, e.g., due to landscaping or the like, conventional closures are not easily repositioned so as to align with the adjusted ground level.

In addition to the lack of post-installation adjustment, conventional pedestal systems are not hermetically sealed. For example, traditional closure systems are prone to problems due to moisture, rodents, insects and vegetation having the potential to migrate into the units.

In addition to the lack of the versatility and hermetic seal, conventional pedestals tend to be large which has prompted communities to write codes requiring communication service providers to place the equipment below ground to enhance the aesthetic appearance of a neighborhood. Pedestal systems are less costly to install than below grade hand holes. Therefore, communication companies are examining all options to provide the most cost effective and practical solutions.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a ground level closure that can address deficiencies found with traditional pedestal installations. In aspects, the innovation can combine benefits of a sealed (e.g., hermetically sealed) system with functionality of a pedestal style enclosure in a small package.

In other aspects, the innovation can provide an ability to store slack cable within a cavity formed by its base assembly. Additionally, the innovation's design enables the ability to disconnect and transport the enclosure to a suitable and controlled work environment as desired. In yet other aspects, the innovation can provide simplified access to and isolation of grounding elements without disrupting the sealed portion of the enclosure during inspection and troubleshooting.

Still further, spacers can be employed in order to adjust height and/or angle of installation. For example, when post-installation landscaping raises the ground level, spacers can be installed so as to raise the height of the closure to better align with the adjusted ground level. Additionally, in other aspects, angular spacers can be employed to raise and aesthetically align the closure, for example, in high-visibility installations.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a perspective view of an example ground level closure (GLC) in accordance with aspects of the innovation.

FIG. 2 illustrates an exploded view of an alternative GLC in accordance with aspects of the innovation.

FIG. 3 illustrates a perspective view of an example GLC base assembly in accordance with an aspect of the innovation.

FIG. 4 illustrates a perspective view of an example spacer adapter assembly in accordance with an aspect of the innovation.

FIG. 5 illustrates a perspective view of an example grounding spacer adapter assembly in accordance with aspects of the innovation.

FIG. 6 illustrates an alternative perspective view of an example grounding adapter in accordance with the innovation.

FIG. 7 illustrates an alternative perspective view of an example grounding adapter in accordance with the innovation.

FIG. 8 illustrates an alternative perspective view of an example grounding adapter in accordance with the innovation.

FIG. 9 illustrates an alternative perspective view of the grounding assembly of an example grounding adapter in accordance with the innovation.

FIG. 10 illustrates an example disassembly by removing a mounting plate and dome assembly in accordance with an aspect of the innovation.

FIG. 11 illustrates a top view of an example mounting plate in accordance with aspects of the innovation.

FIG. 12 illustrates an example collar assembly in accordance with aspects of the innovation.

FIG. 13 illustrates an alternative perspective view of an example GLC in accordance with aspects of the innovation.

FIG. 14 illustrates an example interior organizer portion of a GLC in accordance with aspects of the innovation.

FIG. 15 illustrates an example flow chart of procedures that facilitate adjusting the height of a GLC in accordance with an aspect of the innovation.

FIG. 16 illustrates an example flow chart of procedures that facilitate isolation of grounding studs of a GLC in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

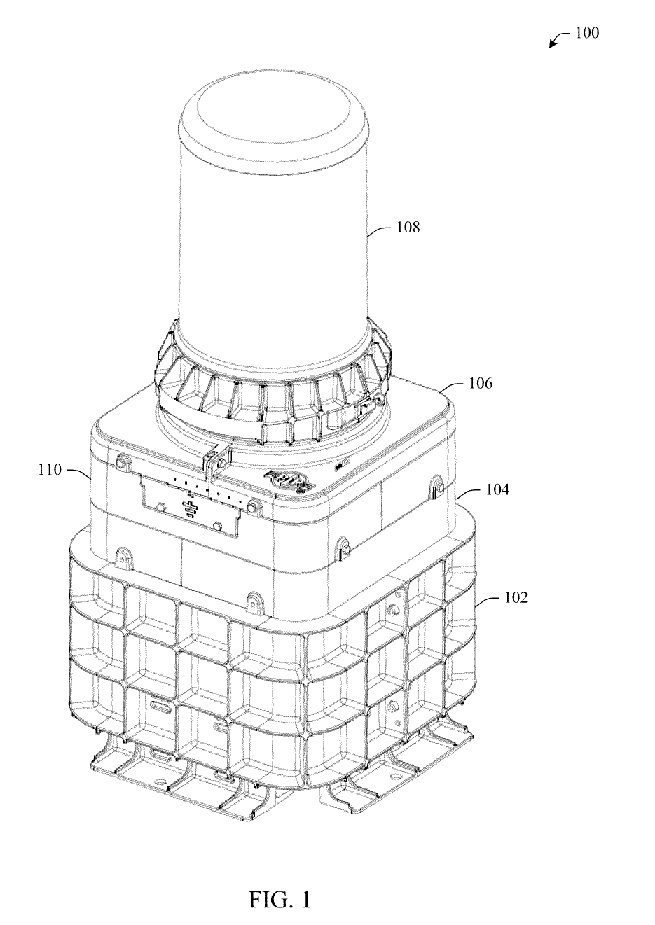

Referring initially to the drawings, FIG. 1 illustrates a perspective view of a ground level closure (GLC) in accordance with an aspect of the innovation. As will be understood upon a review of this specification, the GLC of the innovation can address deficiencies found with traditional pedestal-type closure installations. Additionally, the GLC can combine benefits of a hermetically sealed system with the functionality of a pedestal style enclosure in a small package.

More particularly, the innovation discloses a GLC that can seal (e.g., hermetically seal) the interior organizer assembly within a dome (or other shape) enclosure system. It will be understood that the GLC can combine this sealed enclosure system with the ability to store cable (e.g., excess slack cable) within its base assembly inner cavity. The unique collar assembly together with other components enables the ability to transport the enclosure to a suitably controlled work environment as needed or desired. Further, as described with regard to the optional grounding spacer assembly, the innovation enables simplified access to grounding elements without disrupting the sealed portion of the enclosure during inspection and troubleshooting.

Referring initially to the drawings, FIG. 1 illustrates a perspective view of an example apparatus 100 in accordance with aspects of the innovation. As shown, the apparatus 100, or GLC 100, can include a base assembly 102, spacer assembly 104, mounting platform assembly 106 and dome closure assembly 108. While the example illustrated in FIG. 1 employs a single spacer 104, it will be understood upon a review of the specification that follows that other aspects can include multiple adapters or spacers 104 (e.g., of same or variable width and shape). It is to be understood that adapter and spacer are used interchangeably herein. Additionally, it is possible that examples exist that do not employ an adapter 104. All of these alternative aspects are to be included within the scope of this disclosure and claims appended hereto.

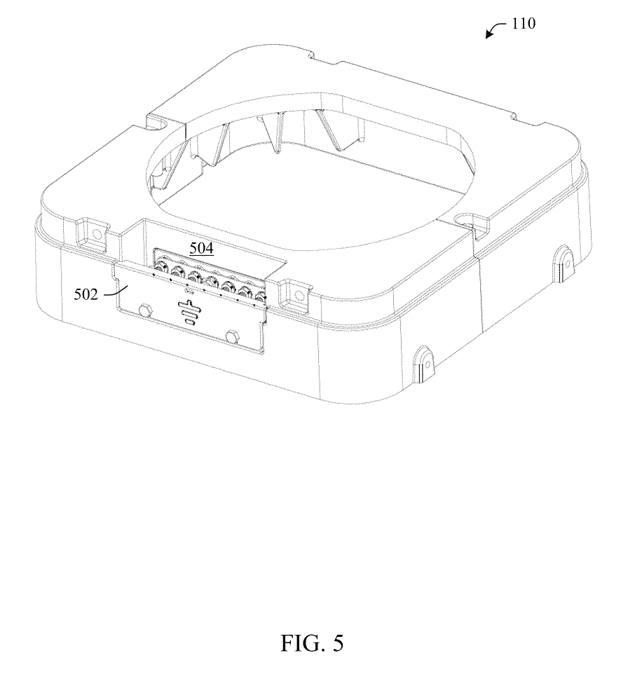

Optionally, GLC 100 can include a grounding spacer assembly 110. This grounding spacer assembly 110 facilitates isolation of individual grounding elements, for example in scenarios of troubleshooting connections and components. Details of this grounding and isolation functionality will be described in greater detail with regard to FIGS. 5 through 9 that follow.

In many example installations that use the GLC 100, a base assembly 102, mounting platform assembly 106 and dome assembly 108 would be employed. In other words, a spacer 104 need not be used in every installation. The quantity and combination of spacers 104 used for an installation can be directly related to the type of cable deployed and geography surrounding the installation (e.g., topography, natural features, physical characteristics). Still further, the number, thickness and orientation (e.g., square profile versus angled profile) can be dependent upon the topography of the ground level before, during or post-installation.

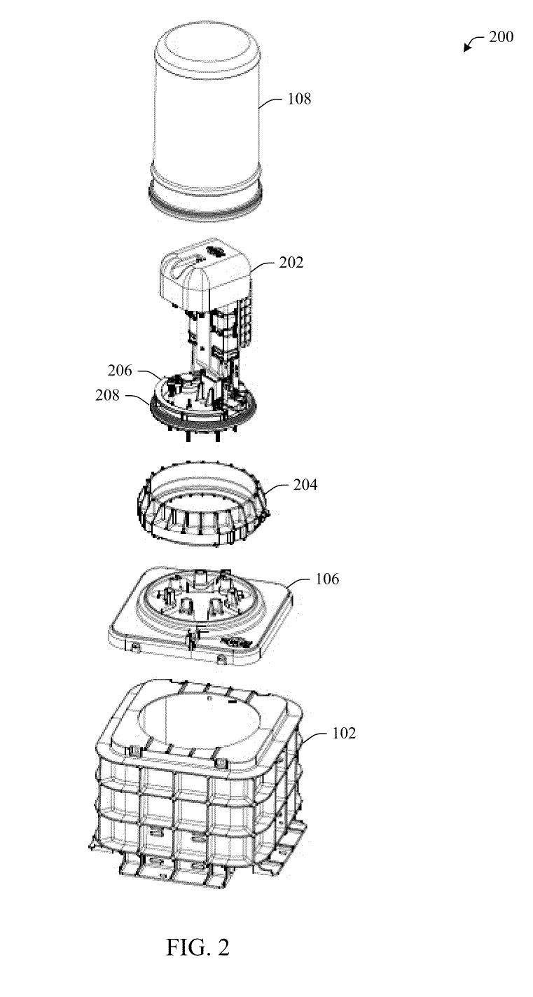

Turning now to FIG. 2, there is illustrated an exploded view of an example GLC 200. As shown, the GLC 200 of FIG. 2 does not include an adapter 104. The explode view of GLC 200 depicts additional (e.g., internal) components such as an organization system 202 that supports a specific application(s) at a closure location. Additionally, a collar assembly 204 is employed to secure the dome 108 onto the end plate system 206 and/or sealing ring 208. Although an adapter or spacer 104 is not included in FIG. 2, it will be understood that spacers and/or adapters 104 can be added, for example, post-initial installation as desired or appropriate to conform to a particular ground level.

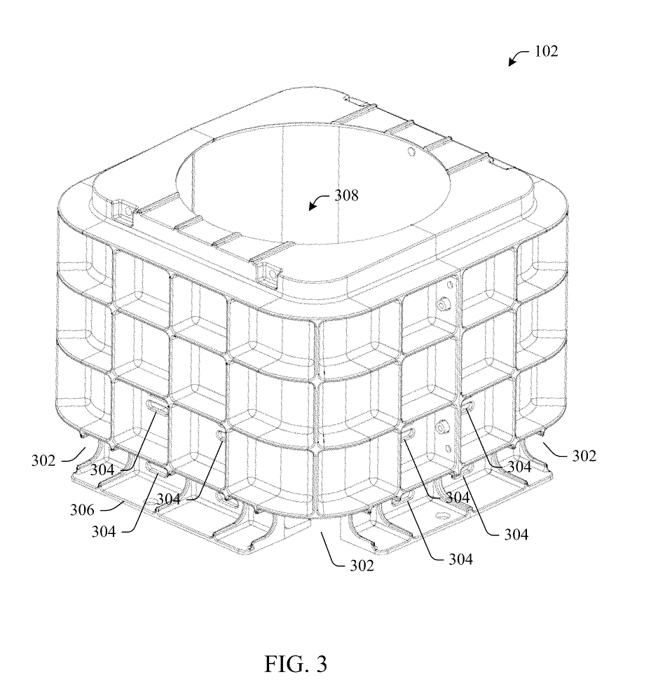

In operation, the base assembly 102 of the GLC 200 is most often buried below ground level, or at least a portion below ground level. FIG. 3 illustrates a perspective view of an example base assembly 102. The base assembly 102 can serve as a storage chamber for slack cable available at the closure location. For example, cable can be stored by coiling the slack within the interior or cavity of the base assembly 102. The base assembly 102 can be manufactured of two identical (or substantially identical) half sections attached to one another. For example, the halves can be press fit, snapped, etc. together so as to construct a unit (e.g., 102) forming a cavity therein. While the manufacturing benefits of identical or substantially identical halves will be appreciated (e.g., single mold), other aspects can employ alternative arrangements without departing from the spirit and/or scope of the innovation. For instance, a single-mold base can be employed in alternative embodiments. Similarly, a single-mold split base (e.g., hinging) can be employed in other alternative embodiments. Still further, a multi-piece base can be employed that need not be configured from identical portions without departing from the spirit and/or scope of the innovation.

The base assembly 102 (as well as other components of the GLC 100, 200) can be manufactured (e.g., molded) from plastic, fiberglass or other suitably rigid material. As well, it is to be understood that the shape of the base assembly 102 illustrated in FIG. 3 is but one example of the base assembly 102. It is to be understood that other examples and aspects exist and are to be included within the scope of this disclosure and claims appended hereto.

With reference to the split design of the base assembly 102, this configuration allows the removal (and installation) of the base assembly 102 from around existing cables without disruption. An opening 302 can be located in each corner of the base assembly 102 that allows cables to transition into and out of the interior cavity of the base assembly 102. Slots 304 can be molded (or otherwise established) into the side walls of the base assembly 102 which provide a means to secure cables. It will be understood that placement and number of slots 304 can be modified as appropriate or desired. In the example of FIG. 3, a flange 306 extends around the perimeter of the base assembly 102 and creates a protective channel for cable passing near the base 102. This flange 306 can also provide a surface to secure the base 102 to restrict vertical movement, for example, in regions that experience seasonal climate changes.

As described above, it is to be understood that the interior cavity 308 can be employed to store cable (e.g., slack cable) as needed or desired. This cavity 308 can be most any size and/or shape as defined by the walls of the base assembly 102. The benefits and functionality of storing cable will be better understood upon a review of the figures that follow.

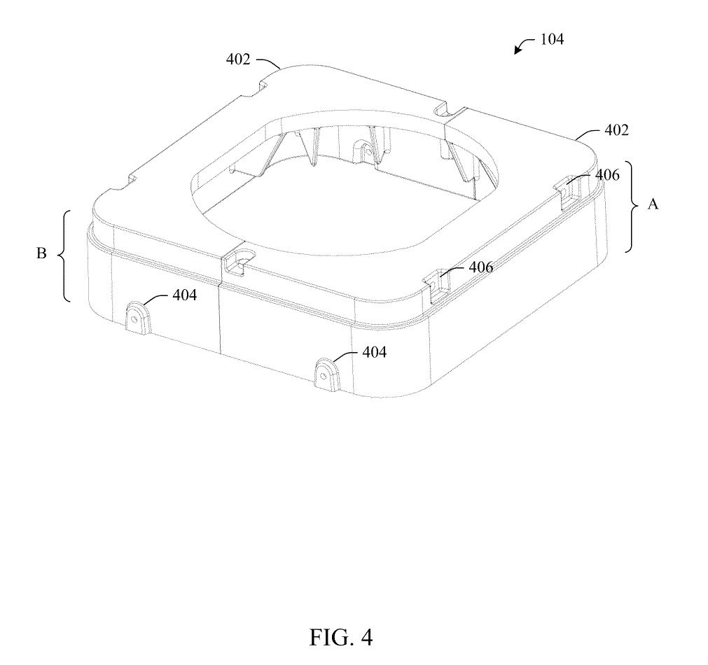

FIG. 4 shows a perspective view of a spacer assembly 104 in accordance with aspects of the innovation. As described with regard to the base assembly 102 of FIG. 3, the spacer assembly 104 can be formed using two identical (or substantially identical) halves 402 fastened or otherwise fixedly connected together. In addition, as desired or appropriate, multiple spacers 104 can be stacked to establish a desired height, for example, to conform to a particular ground level topology. To facilitate stacking spacers 104, each unit 104 can be equipped with attachment means (e.g., 404, 406) which are capable of fixedly attaching one unit to another. Additionally, attachment means 404, 406 can facilitate attachment to a base assembly 102 and/or grounding assembly 110 or mounting platform 106 as illustrated in FIG. 1. While a hardware-based (e.g., bolt-on) connection is illustrated in conjunction with attachment means 404, 406, it is to be appreciated that most any suitable means of connection can be used, including but not limited to, tabs, pins, slots, grooves, etc.

Consistent with the description of base assembly 102, the split-configuration of the spacer 104 can enable removal of the spacer from around existing cables without disturbing or disconnecting the cables. Additionally, single-mold manufacturing can also increase the benefits of utilizing identical half portions. In addition to potentially increasing the cavity volume of the base 102, an additional benefit of the spacer 104 is to permit the GLC 100 to be adjusted to the final grade surrounding the installation. In other words, oftentimes, a GLC (e.g., 100) is installed prior to final grading of the landscape or ground level that surrounds the unit. In the event that the final grading increases the height of the ground level, a spacer (e.g., 104) or group of spacers can be used to raise the height, position or adjust the orientation of the dome 108 to conform to the adjusted level. It will be appreciated that the ability to raise the height after installation can save time and effort in excavating and re-installing as was needed in conventional pedestal installations.

Returning to a description of the spacer 104 of FIG. 4, spacer height “A” can be equal to spacer height “B” as shown. In other words, the spacer 104 can uniformly raise the height in a vertical direction. However, it is to be understood that, in alternative aspects, “A” can be unequal to “B” thereby establishing a slanted or wedge-shaped spacer. This wedge-shaped alternative can be employed in situations where the ground level is finished in a non-parallel plane to an initial installation. In other words, where necessary to achieve a desired aesthetic appearance, wedge-shaped spacers (not shown) can be employed to adjust the height, and vertical orientation, of dome 108. In yet other aspects, a combination of wedge-shaped and block-shaped spacers can be employed to achieve a desired height and/or orientation.

Continuing with a description of features, functions and benefits of spacer 104, if the GLC 100 is installed prior to the final grade being completed, or if adjustments to the height of the installation are required due to ground settling, climate change or other variation, multiple spacer assemblies (block and/or wedge-shaped) can be installed to incrementally increase the height of the installation. As will be appreciated and understood, the use of the spacer assembly 104 eliminates the need to excavate around a base assembly to reset the installation to finished grade.

FIG. 5 illustrates a perspective view of an example grounding spacer assembly 110. As described earlier, use of a grounding spacer assembly 110 is optional and most often dependent upon the type of cabling used in an installation. When installations require that shielded cables or components within the dome closure assembly 108 be connected to ground, an additional type of spacer assembly with features to permit the connection of multiple ground leads can be installed on the base assembly 102. As described with regard to spacer 104 of FIG. 4, grounding spacer assembly 110 can be equipped with attachment means 404, 406 so as to effect proper and/or suitable attachment to components on either side of the spacer 110. Additionally, it is to be understood that alternative shapes (e.g., block widths, wedges, etc.) can be employed without departing from the spirit and/or scope of the innovation.

The grounding spacer assembly 110 as shown in FIG. 5 can enable access to individual ground connection points or studs without disturbing the closure system or cables. In other words, access can be gained without unsealing the unit (e.g., interior organization system) so as to expose it to environmental conditions and possible contamination. Accessing the ground connection points of the GLC (e.g., 100) can provide a location to isolate the ground path for each cable entering the closure location. This isolation functionality is described infra.

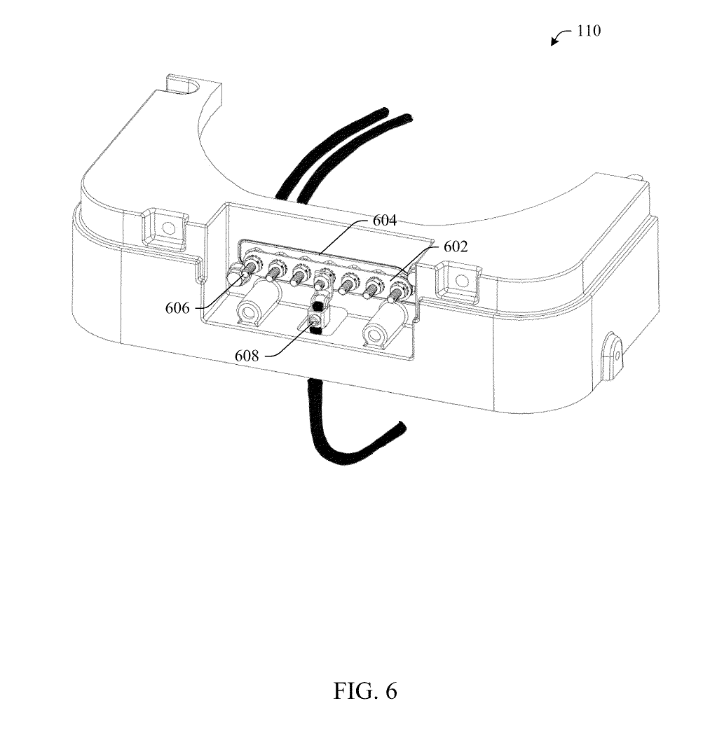

As shown in the example grounding spacer assembly 110 of FIG. 5, an access panel 502 on the exterior of the grounding spacer assembly 110 can cover (or otherwise obscure) a ground connection compartment 504 within the spacer 110. FIG. 6 illustrates the example spacer 110 without the access panel 502. As shown, the access panel 502 can be fixedly attached using screws, bolt, pins, or the like. As well, in alternative aspects, the access panel 502 may not be installed as appropriate or desired. These alternative aspects are to be included within the scope of this disclosure and claims appended hereto.

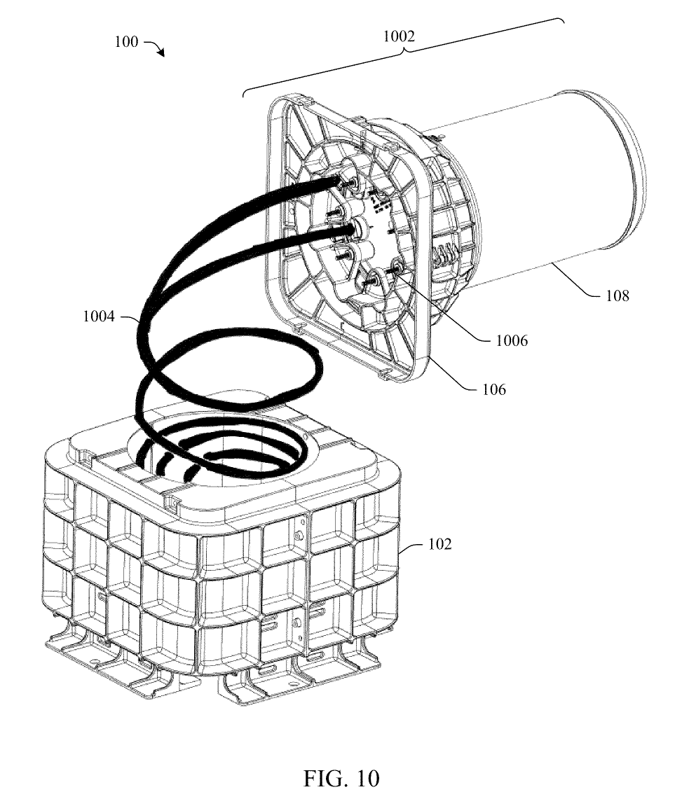

As shown in FIG. 6, removal of the panel (502 of FIG. 5) exposes a grounding strip 602 and a grounding stud panel 604. Ground continuity between all grounding studs 606 in conductive communication with the grounding stud panel 604 can be accomplished by the grounding strip 602 which contacts the face of each ground stud 606 on the panel 604. Each ground stud 606 is connected to an endplate ground stud (shown in FIG. 10 infra) with a ground lead. As will be understood, the endplate ground stud extends through the endplate and serves as an attachment point for the final ground lead that can be attached to a bond connector installed within the cable.

Upon inspecting the ground continuity of the installation, a technician can remove the access panel (502 of FIG. 5) and disconnect the grounding lug 608 that is tied to the primary ground rod (not shown) at the closure location. The technician can then remove the grounding strip 602 that provides continuity between the grounding studs 606 by way of grounding stud panel 604. It is to be understood that the individual ground studs 606 are now exposed and can be probed to determine if there is a fault in a ground path of a cable connected to a specific grounding stud 606. In other words, the innovation provides for an ability to isolate and more easily troubleshoot grounding issues. Once testing or troubleshooting is complete, the grounding strip 602 and grounding lug 608 can be re-connected and, if appropriate, the access panel (502 of FIG. 5) is re-installed.

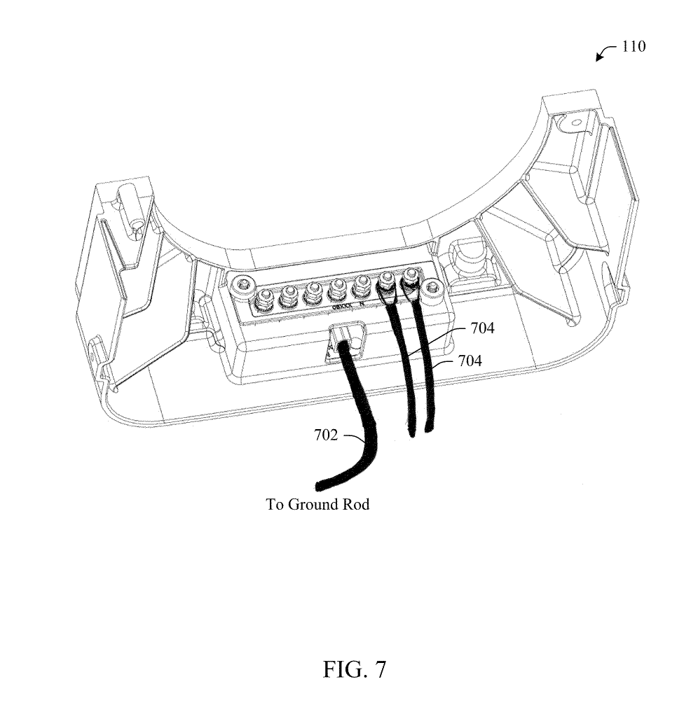

FIG. 7 illustrates an interior view of a grounding spacer assembly (e.g., 110 of FIG. 1) in accordance with aspects of the innovation. As described above, a technician can disconnect the connection 702 to the primary ground rod (not shown). As additionally shown in FIG. 7, ground leads 704 connect each ground stud (606 of FIG. 6) to an endplate ground stud (shown in FIG. 10 infra).

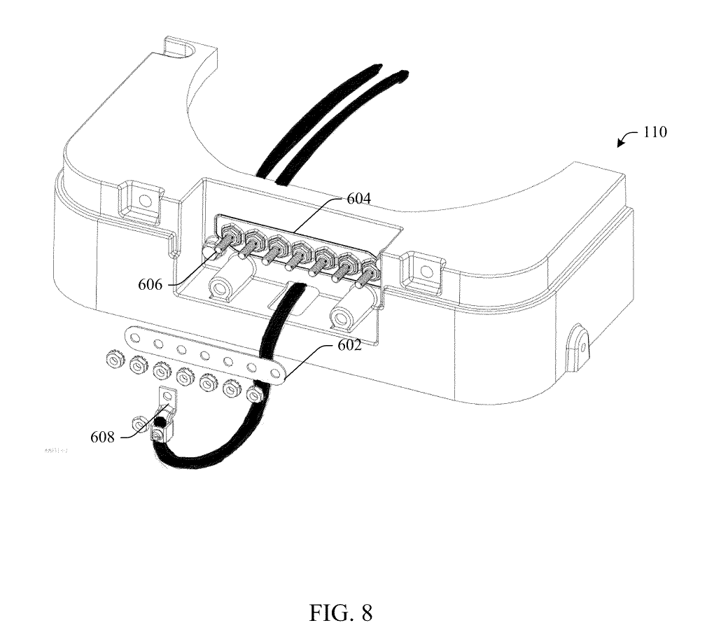

FIG. 8 illustrates an exploded view of the grounding connections as described in detail with regard to FIG. 6 supra. In particular, FIG. 8 provides an understanding of how the grounding strip 602 can provide grounded continuity upon each of the grounding studs 606 when installed and in conductive communication. It is to be understood and appreciated that, while a specific number of studs 606 and continuity therebetween are illustrated in the figures, alternative aspects can be employed with a greater or fewer number of studs 606 as well as continuity means without departing from the scope of the innovation. Still further, while stud-type connectors 606 are shown and described, it is to be appreciated that most any type of connector known in the art can be employed without departing from the spirit and/or scope of the innovation described and claimed herein.

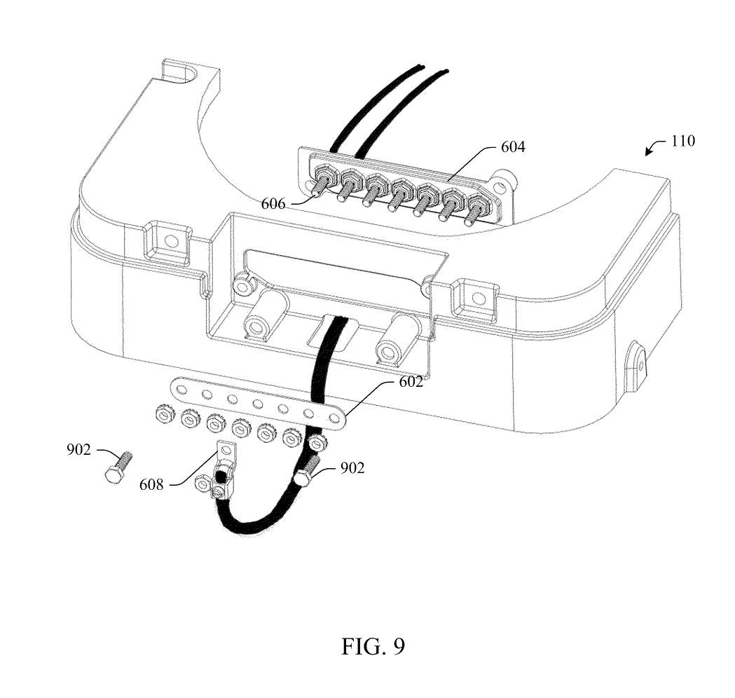

Turning now to FIG. 9, an additional perspective exploded view of grounding adapter assembly 110 is shown in accordance with aspects of the innovation. As illustrated, in this aspect, grounding stud panel 604 can be removed toward the interior of the grounding adapter assembly 110 upon removing the attachment means 902. As described above, although attachment means 902 is a hardware-based means (e.g., screws) in this example, it is to be understood that most any suitable attachment means can be employed in alternative aspects. For instance, bolts, pins, snap-fit, pressure-fit, connectors can be employed in other embodiments.

Continuing with a discussion of the example GLC (e.g., 100, 200) of the innovation, as shown in FIG. 10, when it becomes necessary or desired to perform maintenance, repair, inspection or other installation activities regarding the components within the dome closure 108, the sub-assembly 1002 that includes the dome assembly 108 and mounting platform assembly 106, can be removed from the base assembly 102 or optional spacer assembly (not shown), for example, for transport to a suitable work environment.

As illustrated, removal of the dome assembly 108 and mounting platform sub-assembly 106 is possible without disconnecting any of the existing cables installed in the dome 108 (e.g., to the interior organizer assembly). As the dome/platform sub-assembly 1002 is pulled away from the base, the slack cable 1004 stored within the base assembly 102 uncoils or is otherwise extended.

As described with regard to FIG. 7, in a grounding application, endplate ground stud(s) 1006 can be employed to connect each of the ground leads 704. Each of the ground leads (704 of FIG. 7) can be connected to each ground stud (606 of FIG. 6) and also connected to an endplate ground stud 1002 as shown in FIG. 10.

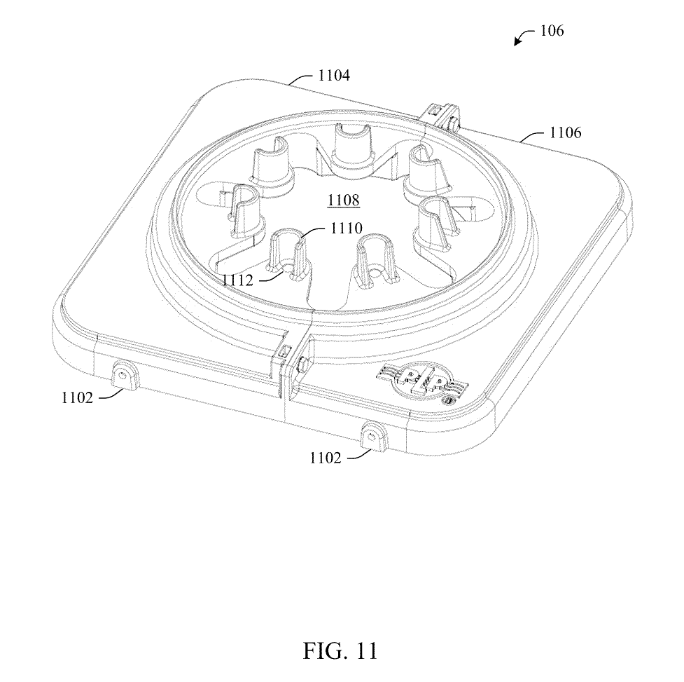

FIG. 11 illustrates a perspective view of an example mounting platform assembly 106 in accordance with aspects of the innovation. As described previously with regard to the base assembly 102 and adapters (e.g., 104, 110), attachment points or means 1102 can be employed to attach the platform assembly 106 to a base assembly 102 or adapter assembly (e.g., 104, 110) as appropriate or desired. Similarly, to enable installation or removal without disruption of existing connections, the platform can be a split-unit formed of multiple portions 1104, 1106 as shown. Thus, to remove or install the platform around existing cabling, the sections 1104, 1106 can be separated, positioned around the cabling and attached once around the existing cables.

Still further, the interior section of platform 106 can be designed or otherwise figured to accommodate most any number of connections. As shown, the platform 106 is configured to accommodate seven (7) connections. In particular, seven cable guides 1110 and connection apertures 1112 are included to effect connections.

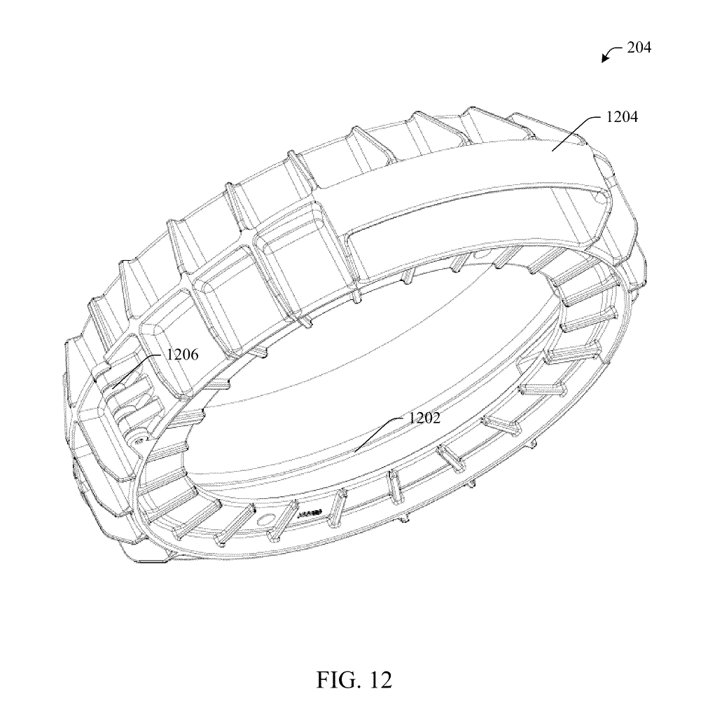

A perspective view of example dome collar 204 is illustrated in FIG. 12. The dome collar assembly 204 is adapted or otherwise configured to enable attachment to platform 106 and dome assembly 108 as illustrated in FIGS. 1 and 2. In particular, collar assembly 204 enables attachment to platform 106 as well as to secure the dome 108 onto the end plate system 206 and/or sealing ring 208. Upon connection to end plate system 206, a sealing ring 208 can seat within groove or track 1202 thereby establishing a seal between the base 102 and the organization system 202 within dome 108. For example, a hermetic or waterproof seal can be established thereby alleviating risk of contamination (e.g., environmental, wildlife) of the organization system 202.

Optionally, a handle 1204, or multiple handles, can be fixedly attached to (or formed/molded within) the collar 204. The handle(s) 1204 integrated into the dome collar can provide a means of gripping the dome/platform sub-assembly 1002 while the sub-assembly 1002 is removed and transported, for example, to a work area. After work is completed, the cable can be re-coiled back into the base and the dome/platform sub-assembly can re-assembled to the base assembly or spacer platform assembly. Additionally, and optionally, as illustrated, collar 204 can include a hinging means 1206 that facilitates a split-unit collar to be installed or removed around existing cables.

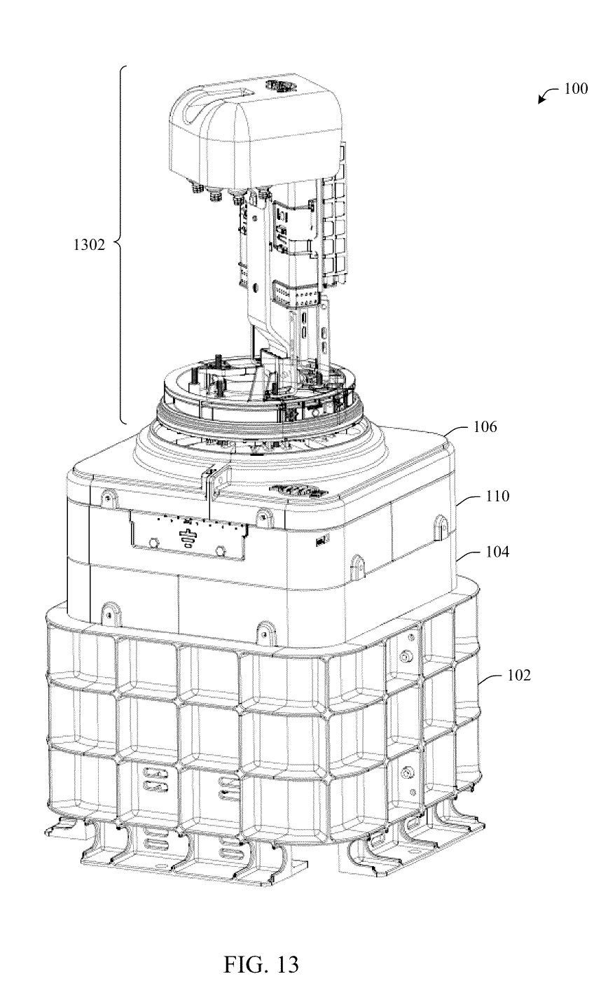

FIG. 13 illustrates an alternative perspective view of GLC 100. In particular, FIG. 13 illustrates an example interior organizer portion 1302 of GLC 100 after the dome 108 and collar 204 have been removed. As shown, the interior 1302 of the GLC 100 can be accessed by removing the collar assembly 204 and the dome 108 while the dome assembly 108 and platform assembly 106 are installed atop the base assembly 102 or spacer assembly 106 or 110.

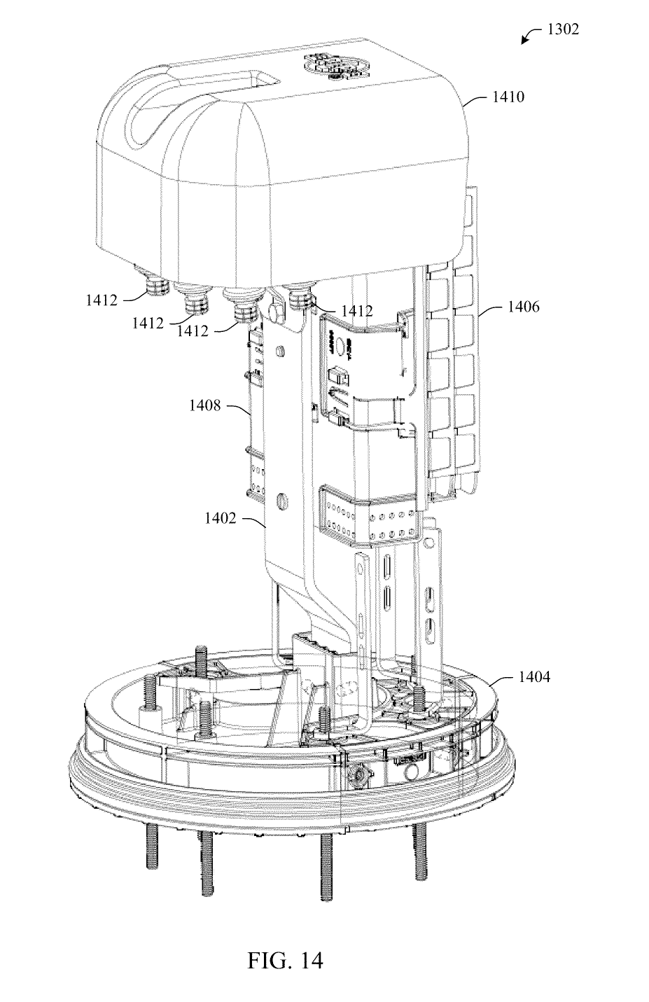

FIG. 14 illustrates an example view of an interior organizer portion of GLC 100. As shown, the interior organizer 1302 of the GLC 100 can be adapted and/or otherwise configured to support a wide variety of applications. By way of example and not limitation, it is to be appreciated that uses can include an interior organizer assembly 1302 that supports straight fiber or copper splicing applications to smaller branch or drop cables for distributing signals beyond the closure location. FIG. 14 displays one example of an internal organizer 1302 that supports fiber connections to pre-terminated drop cables. This assembly 1302 includes a central support bar 1402 which is attached to the end plate assembly 1404 that can secure and seal around incoming cables. Fiber splice trays 1406 and fiber storage trays 1408 can be provided to store and protect both bare fibers and spliced fibers. A shroud 1410 is attached to the central support bar 1402 to protect fibers that are routed between the splice and storage trays 1406, 1408 and the connectors 1412 that are mounted to a bulkhead plate (not shown).

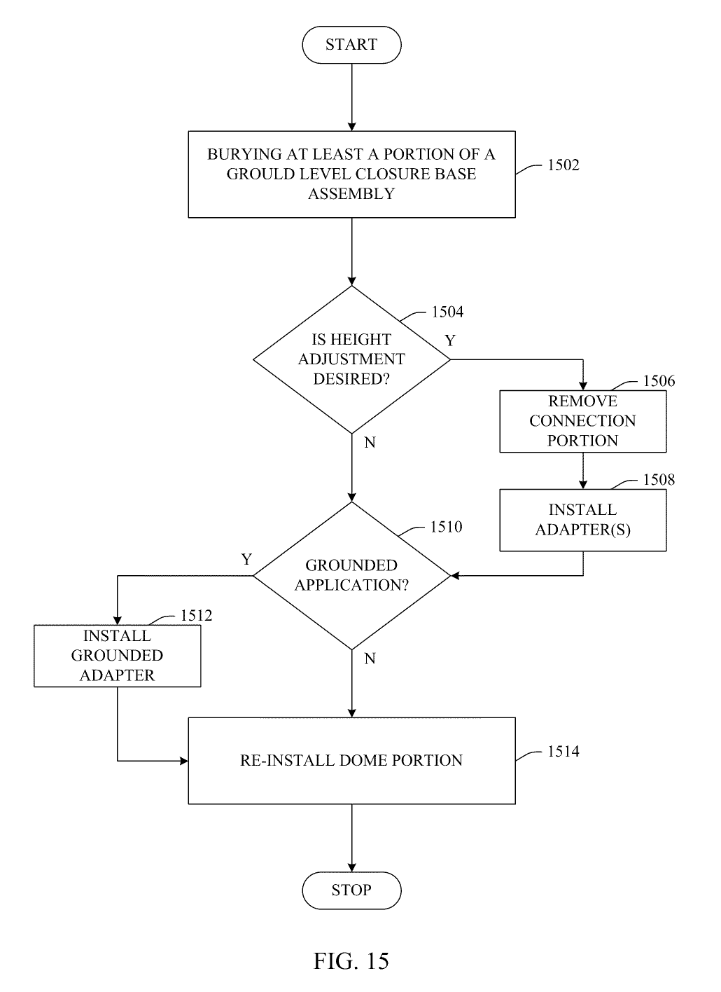

FIG. 15 illustrates a methodology of adjusting the height (or orientation) of a GLC in accordance with an aspect of the innovation. For example, the methodology of FIG. 15 can be employed to adjust the height of a GLC following initial installation to conform to post-installation grade changes. It will be understood that, in many instances, ground level topology is modified thereby prompting height adjustment of the GLC. In traditional installations, closures would have to be excavated, physically re-positioned (e.g., raised) and re-installed. As will be appreciated in accordance with the methodology of FIG. 15, the innovation described herein enables post-installation adjustment as necessary or desired.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. Moreover, not all illustrated acts may be required to implement a methodology in accordance with the innovation.

The installation of a GLC begins at 1502 by burying at least a portion of the base assembly. For example, as illustrated in FIG. 1, base assembly 102 can be buried beneath the surface of the ground. It will be understood that, oftentimes, landscaping and other similar modifications to the level of the ground can affect installation of a GLC. For instance, frequently a pre-installed GLC will have to removed, re-positioned (e.g., raised) and re-installed to conform to a raised ground height.

At 1504, a determination is made to establish if GLC height adjustment is desired, for example, in response to post-initial installation ground level modification (e.g., landscaping). If adjustment is necessary or desired, the connection portion of the GLC can be removed at 1506. For instance, the dome portion (e.g., 108 of FIG. 1) can be removed.

Adapters can be installed at 1508 as appropriate to reach the desired height and/or alignment. For instance, split block-shaped adapters 104 as shown in FIG. 1 can be installed to attain a desired height level. Additionally, split wedge-shaped adapters 110 can be employed to align dome portion 108 as appropriate or desired.

Next, at 1510, a decision is made to establish if a grounded application is appropriate. If so, a ground adapter 1512 can be installed. For instance, a grounding adapter assembly 110 as shown and described with regard to FIG. 1 can be employed.

Finally, at 1514, the dome portion can be re-installed at the adjusted height. It will be understood that, a grounding adapter assembly (e.g., 110) need not be installed post-initial installation. Rather, it will be understood that, as appropriate, a grounding adapter can be employed upon initial installation. Additionally, although the use of adapters is described in a post-initial installation scenario, it is to be understood that adapters can be used during the initial installation as appropriate and/or desired.

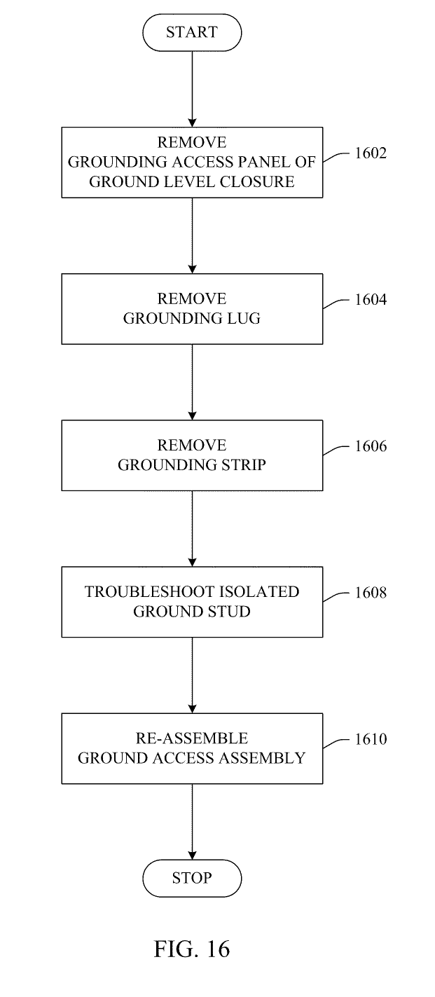

Referring now to FIG. 16, there is illustrated a methodology of isolating grounding pins in accordance with aspects of the innovation. As described with regard to FIGS. 1 and 5 through 9, a grounding adapter (e.g., 110) can be employed to enable isolation of individual grounding connections of a GLC. In doing so, at 1602, a grounding access panel can be removed. As described above, removal of the panel exposes the grounding studs of the GLC.

At 1604, a grounding lug can be removed to effectively disconnect the ground from the GLC. The grounding strip can be removed at 1606. As previously discussed, this grounding strip uniformly grounds all of the ground pins or studs together. Once the interconnection (e.g., grounding strip) is removed at 1606, each grounding stud can be isolated, for example, to enable troubleshooting. Once isolation-based work is complete, the grounding assembly can be re-assembled.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ground level closure (GLC) system, comprising:
a base assembly shaped to form an interior hollow cavity, wherein the interior hollow cavity facilitates storage of a length of cable and wherein the base assembly comprises an open top surface;
a mounting plate adapted to removably attach atop the open top surface of the base assembly; and
a dome assembly removably attached to the mounting plate opposite the base assembly, wherein the dome assembly is hermetically sealed and houses an interior organizer portion of the closure system, and wherein the mounting plate is adapted to facilitate removal of the dome assembly from the base assembly.

2. The GLC system of claim 1, wherein the base assembly is a split-unit base assembly that facilitates installation around existing cabling.

3. The GLC system of claim 1, further comprising a spacer assembly that fixedly attaches between the top surface of the base assembly and the mounting plate, wherein the spacer assembly adjusts orientation of the dome assembly relative to the base assembly.

4. The GLC system of claim 3, wherein the spacer assembly is a split-unit spacer assembly that facilities installation around existing cabling.

5. The GLC system of claim 4, wherein the spacer assembly comprises a plurality of individual spacers.

6. The GLC system of claim 3, wherein the spacer assembly is block-shaped spacer.

7. The GLC system of claim 3, wherein the spacer assembly is a wedge-shaped spacer.

8. The GLC system of claim 3, wherein the spacer assembly is a grounding spacer.

9. The GLC system of claim 8, wherein the grounding spacer facilitates isolation of each of a plurality of grounding studs.

10. The GLC system of claim 1, further comprising a collar that fixedly attaches the dome assembly to the mounting plate assembly, wherein the collar enables installation around existing cabling.

11. The GLC system of claim 1, wherein the mounting plate is a split-unit mounting plate that facilitates installation around existing cabling.

12. A method for installing a ground level closure (GLC), comprising:
burying at least a portion of a base assembly;
attaching a spacer assembly to a top portion of the base assembly; and
attaching a mounting plate to a top portion of the spacer assembly, wherein the mounting plate supports a dome assembly that houses an internal organizer assembly.

13. The method of claim 12, wherein an interior organizer assembly is hermetically sealed within the dome assembly.

14. The method of claim 12, wherein the spacer assembly is a block-shaped spacer assembly.

15. The method of claim 12, wherein the spacer assembly is a wedge-shaped spacer assembly.

16. The method of claim 12, wherein the spacer assembly is a grounding spacer assembly that facilitates isolation of each of a plurality of grounding studs.

17. The method of claim 12, wherein the base assembly, spacer assembly and mounting plate are each split-unit assemblies that facilitate installation around existing cabling.

18. A ground level closure apparatus, comprising:
a split-unit base assembly that comprises four sidewalls, a bottom portion and an open top portion that forms a cavity therein, wherein the cavity facilitates storage of a length of slack cable;
a split-unit spacer assembly that fixedly attaches to the top portion of the base assembly;
a split-unit grounding assembly that fixedly attaches to a top portion of the spacer assembly;
a split-unit mounting plate assembly that attaches to a top portion of the grounding assembly;
a split-unit collar assembly that attaches to an upper portion of the mounting plate assembly; and
a dome assembly that comprises an end plate and sealing ring that hermetically seal an interior organizer assembly within the dome assembly.

19. The ground level closure apparatus of claim 18, wherein the grounding assembly facilitates isolation of each of a plurality of grounding studs.

20. The ground level closure apparatus of claim 18, wherein the collar assembly comprises at least one handle that facilitates removal of the dome assembly from the base assembly.
